(19) United States
(12) Patent Application Publication
(10) Pub. No.: US 2023/0327172 A1
(43) Pub. Date: Oct. 12, 2023

(54) APPARATUS FOR MANUFACTURING ALL-SOLID-STATE BATTERY

(71) Applicant: HONDA MOTOR CO., LTD., Tokyo (JP)

(72) Inventors: Takashi TOYOSHIMA, Saitama (JP); Kosei MIYATA, Saitama (JP); Kenta UMETSU, Saitama (JP); Yohei NOJI, Saitama (JP)

(21) Appl. No.: 18/185,398

(22) Filed: Mar. 17, 2023

(30) Foreign Application Priority Data
Mar. 30, 2022 (JP) 2022-057203

(51) Int. Cl. H01M 10/04

(52) U.S. Cl. CPC H01M 10/0404

(57) ABSTRACT

Provided is an apparatus for manufacturing an all-solid-state battery with high efficiency. An apparatus for manufacturing an all-solid-state battery includes: a conductor conveyor configured to convey a conductor adapted to function as an electrode that is an element of the all-solid-state battery; an insulator conveyor configured to convey an insulator adapted to function as an insulating member that is an element of the all-solid-state battery; a cutter configured to form, in the insulator, a cut in correspondence with the shape of the insulating member; and a laminator-pressurizer configured to laminate and pressurize the conductor conveyed by the conductor conveyor and the insulator having the cut formed by the cutter.

This application is based on and claims the benefit of priority from Japanese Patent Application No. 2022-057203, filed on Mar. 30, 2022, the content of which is incorporated herein by reference.

### BACKGROUND OF THE INVENTION

### Field of the Invention

The present invention relates to an apparatus for manufacturing an all-solid-state battery.

### Related Art

A technique has been proposed in which all-solid-state batteries are manufactured by way of a hot roll press process (see, for example, Japanese Unexamined Patent Application, Publication No. 2021-150183). A technique has been proposed in which a solid electrolyte layer, a positive electrode mixture layer, and a negative electrode mixture layer are press-bonded while the layers are in a soft state immediately after a coating process, thereby obtaining dense interfaces whose bonded portions are devoid of voids (see for example, Japanese Unexamined Patent Application, Publication No. 2015-118870). A technique has been proposed in which an insulating member is disposed on a portion of a side surface of a positive electrode layer or a negative electrode layer whichever has a smaller area, whereby alignment is facilitated when the positive electrode layer and the negative electrode layer are stacked and pressed (see, for example, Japanese Unexamined Patent Application, Publication No. 2015-125893).
Patent Document 1: Japanese Unexamined Patent Application, Publication No. 2021-150183
Patent Document 2: Japanese Unexamined Patent Application, Publication No. 2015-118870
Patent Document 3: Japanese Unexamined Patent Application, Publication No. 2015-125893

### SUMMARY OF THE INVENTION

While the techniques disclosed in Japanese Unexamined Patent Application, Publication Nos. 2021-150183 and 2015-118870 are considered to have high manufacturing efficiency due to the roll press employed therein, the techniques lack a particular viewpoint with respect to an insulating member to be disposed. Japanese Unexamined Patent Application, Publication No. 2015-125893 does not refer to how or where the insulating member should be disposed in a case of employing the roll press.

The present invention has been achieved in view of the above circumstances, and an object of the present invention is to provide an apparatus for manufacturing an all-solid-state battery, which is capable of forming a laminate including an electrode and an insulating member appropriately bonded to each other while conveying the electrode and the insulating member in parallel and achieving high manufacturing efficiency. It is another object of the present invention to provide a manufacturing apparatus capable of dramatically improving efficiency in manufacture of batteries of this type.

A first aspect of the present invention is directed to an apparatus for manufacturing an all-solid-state battery (e.g., an apparatus 1 for manufacturing an all-solid-state battery to be described later). The apparatus includes: a conductor conveyor (e.g., an electrode element conveying system 6 to be described later) configured to convey a conductor (e.g., a positive electrode conductor element 9, a negative electrode conductor element 10 to be described later) adapted to function as an electrode (e.g., a positive electrode 1a, a negative electrode 1b to be described later) that is an element of the all-solid-state battery; an insulator conveyor (e.g., a back-side electrode frame film conveying system 4, a front-side electrode frame film conveying system 5 to be described later) configured to convey an insulator (e.g., an insulating frame film 7 to be described later) adapted to function as an insulating member (e.g., an insulating frame 2 to be described later) that is an element of the all-solid-state battery; a cutter (e.g., a rotary die cutter 13a, a rotary die cutter 13b to be described later) configured to punch and cut the insulator in correspondence with a shape of the insulating member; and a laminator-pressurizer (e.g., a press roller 18 to be described later) configured to laminate and pressurize the conductor conveyed by the conductor conveyor and the insulator having the cut formed by the cutter.

A second aspect of the present invention is an embodiment of the first aspect. In the apparatus for manufacturing an all-solid-state battery according to the second aspect, the insulator conveyor conveys the insulator together with a carrier sheet (e.g., an applicator film 8 to be described later) while fitting the carrier sheet on the insulator such that the insulator and the carrier sheet are layered on each other, and the cutter forms a cut in the insulator being conveyed by the insulator conveyor.

A third aspect of the present invention is an embodiment of the first aspect. In the apparatus for manufacturing an all-solid-state battery according to the third aspect, at least one of the conductor conveyor or the insulator conveyor includes a tensioner (e.g., an adjustment mechanism 16 to be described later) configured to hold the conductor or the insulator under a tension in an area upstream of the laminator-pressurizer in a conveying direction of the conductor conveyor and the insulator conveyor.

A fourth aspect of the present invention is an embodiment of the first aspect. The apparatus for manufacturing an all-solid-state battery according to the fourth aspect further includes a peeler (e.g., an upper peeling roll 21a, a lower peeling roll 21b, and an upper scrap-removing roll 22a, a lower scrap-removing roll 22b to be described later) provided downstream of the laminator-pressurizer in a conveying direction of the insulator conveyor and configured to peel off a portion of the insulator, the portion being other than a portion shaped by the cutter into the insulating member that is the element of the all-solid-state battery.

In the apparatus according to the first aspect, the conductor conveyor, the insulator conveyor, the cutter, and the laminator-pressurizer function while continuing the conveying operation. As a result, the apparatus can manufacture the all-solid-state batteries with high efficiency.

In the apparatus according to the second aspect, the cutter forms, in the insulator fitted on and conveyed together with the carrier sheet, such a halfway cut that allows a portion of the insulator to be peeled off. As a result, the insulator subjected to the cutting also continues to be conveyed together with the carrier sheet.

In the apparatus according to the third aspect, the tensioner holds the conductor or the insulator under a tension in an area upstream of the laminator-pressurizer in the conveying direction. This feature makes the conductor or the insulator free from slack. As a result, the conductor or the insulator is appropriately laminated and pressurized.

The apparatus according to the fourth aspect removes a portion of the insulator as an unnecessary portion, which is other than a portion shaped as the insulating member that is one element of the all-solid-state battery. Due to this feature, the all-solid-state batteries including the insulating member devoid of the unnecessary portion are successively manufactured.

### BRIEF DESCRIPTION OF THE DRAWINGS

FIG. 1A is a diagram illustrating a positive electrode of an all-solid-state battery manufactured by an apparatus for manufacturing an all-solid-state battery according to an embodiment;

FIG. 1B is a diagram illustrating a negative electrode of an all-solid-state battery manufactured by the apparatus for manufacturing an all-solid-state battery according to the embodiment;

FIG. 2 is a schematic diagram illustrating a first conveyance system in the apparatus for manufacturing an all-solid-state battery according to the embodiment;

FIG. 3 is a process diagram illustrating a process performed in the first conveyance system of FIG. 2;

FIG. 4A is a plan view illustrating a halfway cut processing performed in the first conveyance system of FIG. 2;

FIG. 4B is a side view illustrating the halfway cut processing of FIG. 4A;

FIG. 5A is a side view illustrating an insulating frame in an insulating frame bonding step performed in the first conveyance system of FIG. 2;

FIG. 5B is a plan view illustrating the insulating frame in an insulating frame conveying step performed in the first conveyance system of FIG. 2;

FIG. 5C is a side view illustrating the insulating frame in an insulating frame step performed in the first conveying system of FIG. 2;

FIG. 6 is a schematic view illustrating an alternative configuration for the first conveyance system in the apparatus for manufacturing an all-solid-state battery according to the embodiment;

FIG. 7 is a process diagram illustrating a process performed in the conveyance system having the alternative configuration of FIG. 6;

FIG. 8 is a side view illustrating an insulating frame in an insulating frame step performed in the first conveyance system of FIG. 7;

FIG. 9 is a schematic diagram illustrating a second conveyance system in the apparatus for manufacturing an all-solid-state battery according to the embodiment;

FIG. 10 is a process diagram illustrating a process performed in the second conveyance system of FIG. 9;

FIG. 11 is an enlarged schematic view of a positive electrode laminate sheet formed in the second conveyance system of FIG. 9;

FIG. 12 is an enlarged schematic view of a negative electrode laminate sheet formed in the second transport system of FIG. 9; and

FIG. 13 is a diagram illustrating an all-solid-state battery laminate formed by way of a process performed in the second conveyance system of FIG. 9.

### DETAILED DESCRIPTION OF THE INVENTION

Embodiments of the present invention will be described with reference to the accompanying drawings. In the drawings, the same components or corresponding components are denoted by the same reference sign.

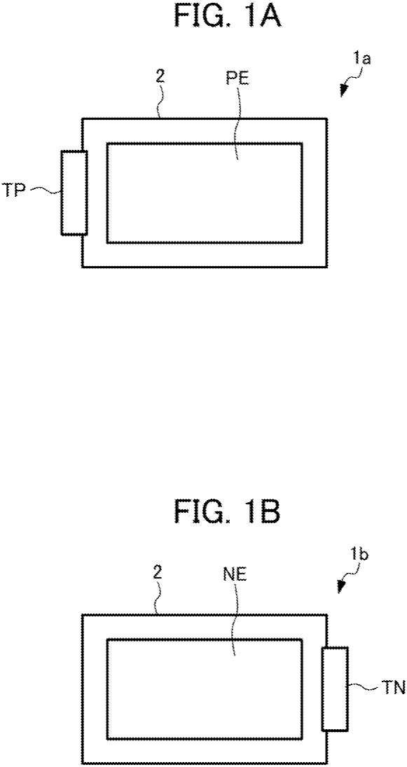

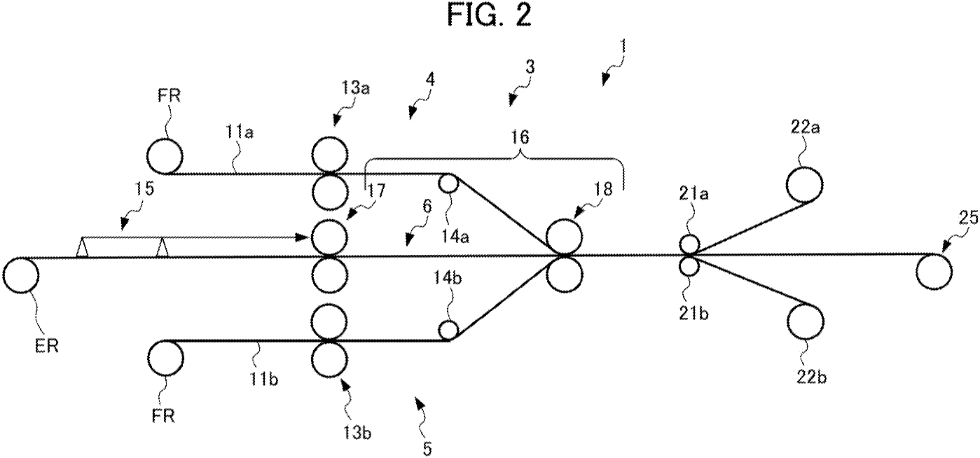

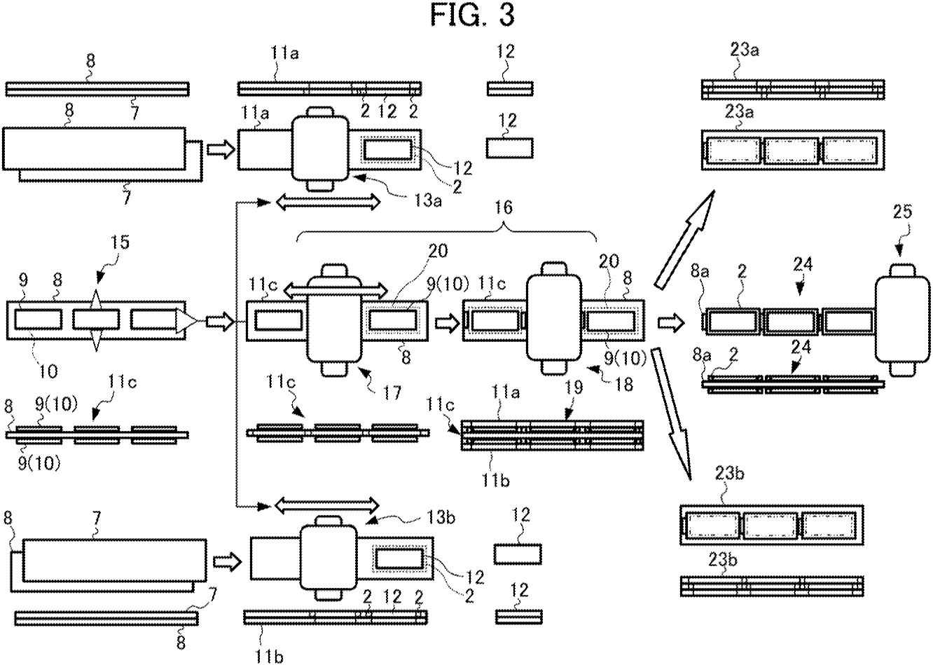

FIGS. 1A and 1B respectively illustrate a positive electrode and a negative electrode of an all-solid-state battery manufactured by an apparatus for manufacturing an all-solid-state battery (which may hereinafter be referred to as the manufacturing apparatus) as an embodiment of the present invention. FIG. 2 is a schematic diagram illustrating a first conveyance system in the manufacturing apparatus, and FIG. 3 is a process diagram illustrating a process performed in the first conveyance system.

The positive electrode 1a illustrated in FIG. 1A includes a thin plate-shaped positive electrode conductor PE, an insulating frame 2 surrounding the positive electrode conductor PE, and a positive electrode tab TP extending from one side of the insulating frame 2. The negative electrode 1b illustrated in FIG. 1B includes a thin plate-shaped negative electrode conductor NE, an insulating frame 2 surrounding the negative electrode conductor NE, and a negative electrode tab TN extending from an opposite side of the insulating frame 2. Note that here the positions from which the tabs extend are referred to as the one side and the opposite side from a viewpoint at the time of lamination, which will be described later, and it is needless to say that the positions coincide with each other when the left and right in FIG. 1B are reversed.

FIG. 2 illustrates a manufacturing apparatus 1 as an embodiment of the present invention, and the manufacturing apparatus 1 has a configuration for performing the process schematically illustrated in FIG. 3. A first conveyance system 3 in FIG. 2 includes a back-side electrode frame film conveying system 4, a front-side electrode frame film conveying system 5, and an electrode element conveying system 6. The back-side electrode frame film conveying system 4 is fed with a conveyable sheet 11a having a first structure, which will be described later, from an insulating frame film roll FR. The front-side electrode frame film conveying system 5 is fed with a conveyable sheet 11b having a second structure, which will be described later, from an insulating frame film roll FR. The electrode element conveying system 6 is fed with a conveyable sheet 11c having a third structure, which will be described later, from an electrode element conveyable sheet roll ER.

The back-side electrode frame film conveying system 4 conveys an insulating frame film 7 while fitting the insulating frame film 7 on the back surface (lower surface in FIG. 2) of an applicator film 8 that functions as a carrier, and thereby subjects the films 7 and 8 to processing. The insulating frame film 7 is a strip-shaped insulating member that is to be shaped into the insulating frame 2.

The front-side electrode frame film conveying system 5 conveys an insulating frame film 7 while fitting the insulating frame film 7 on the front surface (upper surface in FIG. 2) of an applicator film 8 that functions as a carrier, and thereby subjects the films 7 and 8 to processing. The back-side electrode frame film conveying system 4 and the front-side electrode frame film conveying system 5 are each an insulator conveyor for conveying an insulator (e.g., the insulating frame film 7) adapted to function as an insulating member (e.g., the insulating frame 2), which is an element of the all-solid-state battery.

The electrode element conveying system 6 conveys positive electrode conductor elements 9 (such as aluminum foils) that function as the positive electrodes 1a or negative electrode conductor elements 10 (such as copper foils) that function as the negative electrodes 1b, while fitting the conductor elements 9 or 10 on the front and back surfaces of an applicator film 8, and thereby subjects them to processing. The electrode element conveying system 6 is a conductor conveyor for conveying conductors (the positive electrode conductor elements 9, the negative electrode conductor elements 10) adapted to function as the electrodes (the positive electrodes 1a, negative electrodes 1b), which are elements of the all-solid-state battery.

The back-side electrode frame film conveying system 4 conveys the conveyable sheet 11a with the first structure including the insulating frame film 7 fitted on the applicator film 8, while the front-side electrode frame film conveying system 5 conveys the conveyable sheet 11b with the second structure including the insulating frame film 7 fitted on the applicator film 8.

The back-side electrode frame film conveying system 4 is provided with a rotary die cutter 13a that punches, in the conveyable sheet 11a with the first structure, a window-shaped opening corresponding to the inside of the insulating frame 2, and discards the window-shaped punched scrap 12. The rotary die cutter 13a further forms a halfway cut in correspondence with the outer contour of the insulating frame 2, without completely cutting the applicator film 8 of the conveyable sheet 11a with the first structure. On the downstream side of the rotary die cutter 13a, an assistance roll 14a is provided which assists the discard of the window-shaped punched scrap 12.

The front-side electrode frame film conveying system 5 is provided with a rotary die cutter 13b that punches, in the conveyable sheet 11b with the second structure, a window-shaped opening corresponding to the inside of the insulating frame 2, and discards the window-shaped punched scrap 12. The rotary die cutter 13b further forms a halfway cut in correspondence with the outer contour of the insulating frame 2, without completely cutting the applicator film 8 of the conveyable sheet 11b with the second structure.

On the downstream side of the rotary die cutter 13b, an assistance roll 14b is provided which assists the discard of the window-shaped punched scrap 12. The rotary die cutter 13a and the rotary die cutter 13b are each a cutter for punching and cutting the insulator (the insulating frame film 7) in correspondence with the shape of the insulating member (the insulating frame 2), which is an element of the all-solid-state battery.

The electrode element conveying system 6 conveys the conveyable sheet 11c with the third structure including the positive electrode conductor elements 9 or the negative electrode conductor elements 10 fitted on both the front and back surfaces of the applicator film 8. The electrode element conveying system 6 is provided with an adjustment mechanism 16 that adjusts a tension acting on the conveyable sheet 11c having the third structure and a positional phase relating to conveyance, based on a detection output from a positional phase sensor 15 that detects in a non-contact manner positions of the positive electrode conductor elements 9 or the negative electrode conductor elements 10 on the conveyable sheet 11c with the third structure.

The adjustment mechanism 16 includes a phase control rotary die 17, a press roller 18, and a control circuit (not shown), and functions also as a tensioner. The rotation speed of the phase control rotary die 17 is controlled based on a detection output from the positional phase sensor 15. The press roller 18 laminates the conveyable sheet 11a with the first structure conveyed by the back-side electrode frame film conveying system 4 and the conveyable sheet 11b with the second structure conveyed by the front-side electrode frame film conveying system 5 on the upper and lower surfaces of the conveyable sheet 11c with the third structure, and pressurizes the sheets laminated together.

The press roller 18 is a laminator-pressurizer that pressurizes a laminate 19 formed by laminating the conductors (the positive electrode conductor elements 9, the negative electrode conductor elements 10) conveyed by the conductor conveyor (the electrode element conveying system 6) on the insulator (the insulating frame film 7) having the cuts formed by the cutter (the rotary die cutter 13b). The phase control rotary die 17 has a functional portion (not shown) as a cutter that forms, with respect to the applicator film 8 of the conveyable sheet 11c with the third structure, halfway cuts as incisions 20 each having the shape of the outer peripheral edge of the insulating frame 2 and surrounding the positive electrode conductor element 9 or the negative electrode conductor element 10.

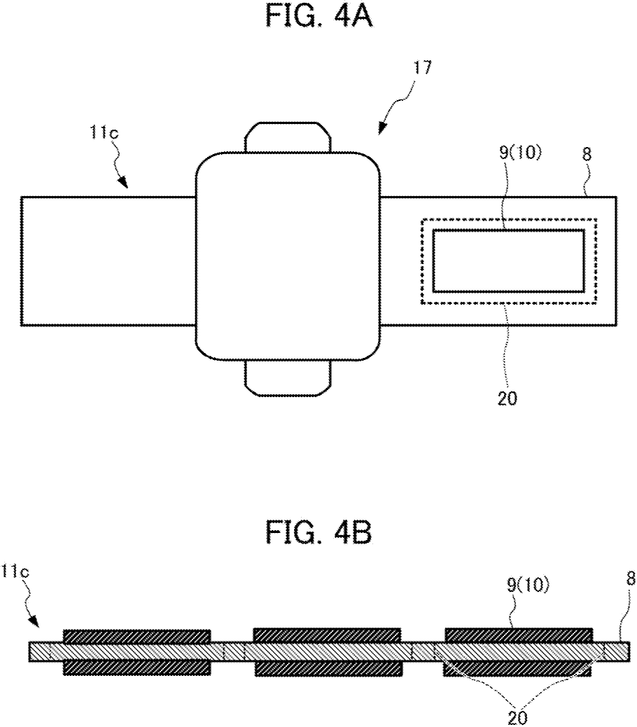

FIG. 4A is an enlarged schematic view illustrating how the phase control rotary die 17 functions as a cutter. FIG. 4B is an enlarged schematic view illustrating a state in which the applicator film 8 has therein the incisions 20 formed by the phase control rotary die 17. The incisions 20 are formed such that in a central portion of the applicator film 8 extending in the conveying direction, a part to function as a carrier belt 8a remains without being cut off.

Further, the phase control rotary die 17 adjusts a rotational phase relative to the press roller 18 so as to stretch and maintain the applicator film 8 under an appropriate tension to thereby prevent slack. Consequently, the phase control rotary die 17 holds the conductors (the positive electrode conductor elements 9, the negative electrode conductor elements 10) on the applicator film 8 under a tension so as to prevent slack.

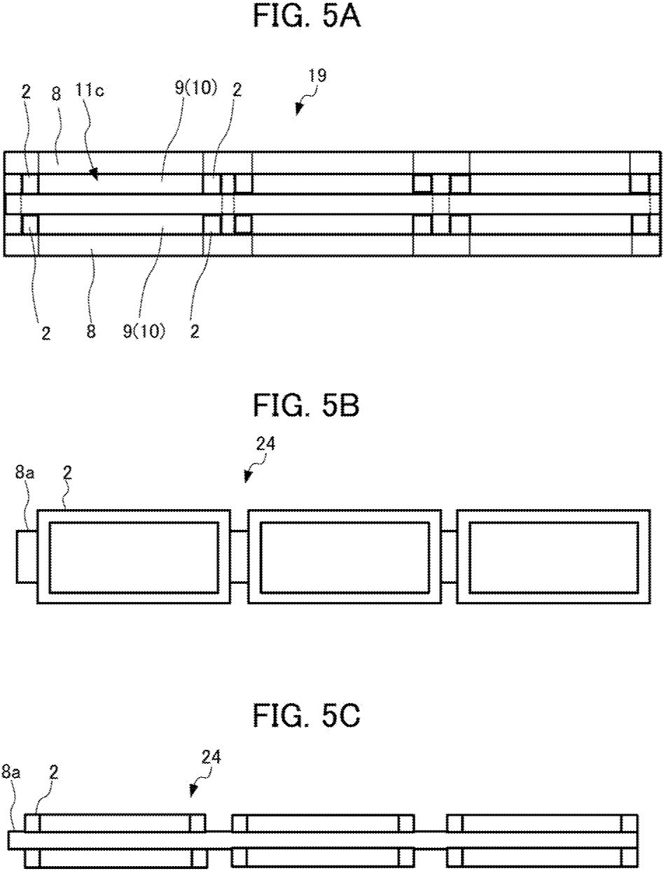

FIG. 5A is an enlarged schematic view of the laminate 19 pressurized by the press roller 18. An upper peeling roll 21a, a lower peeling roll 21b, an upper scrap-removing roll 22a, and a lower scrap-removing roll 22b are provided downstream of the press roller 18. The upper peeling roll 21a separates, from the pressurized laminate 19, an unnecessary portion 23a mainly composed of the applicator film 8 as an upper layer, and the upper scrap-removing roll 22a winds up the unnecessary portion 23a.

The lower peeling roll 21b separates, from the pressurized laminate 19, an unnecessary portion 23b composed of the applicator film 8 as a lower layer, and the lower scrap-removing roll 22b winds up the unnecessary portion 23b. The laminate 19 from which the unnecessary portions composed of the upper and lower applicator films 8 have been removed turns into a sheet-shaped continuous body 24 continuing by way of the carrier belt 8a described above, and is wound up around a winding roll 25. FIG. 5B is a schematic plan view illustrating the continuous body 24 on an enlarged scale. FIG. 5C is a schematic side view illustrating the continuous body 24 on an enlarged scale.

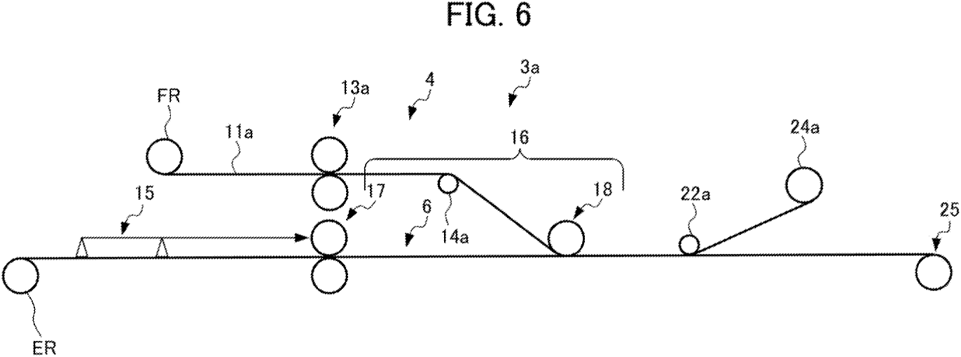

FIG. 6 is a schematic view illustrating an alternative configuration for the first conveyance system in the apparatus for manufacturing an all-solid-state battery according to the present embodiment. In FIG. 6, components corresponding to those in FIG. 2 are denoted by the same reference signs, and the description of each of the components denoted by the same reference signs in FIG. 2 applies to the corresponding component in FIG. 6. The first conveyance system 3a of FIG. 6 differs from the first conveyance system 3 of FIG. 2 in that the first conveyance system 3a does not include the front-side electrode frame film conveying system 5 while the rest of the components of the first conveyance system 3a are the same as those of the first conveyance system 3 of FIG. 2.

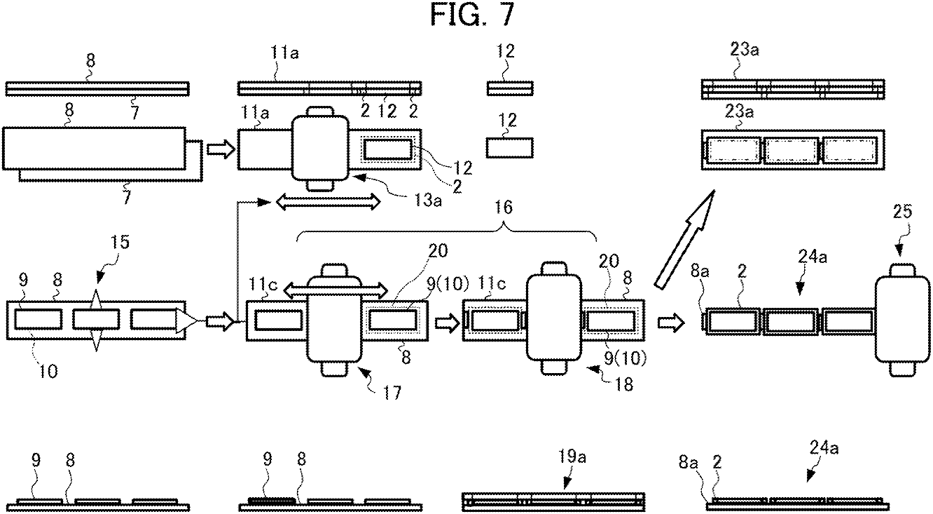

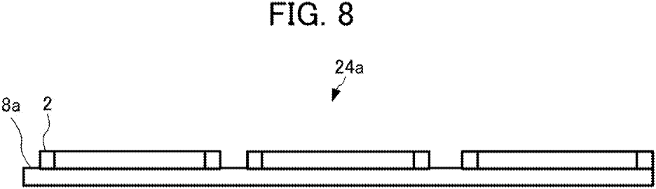

FIG. 7 is a process diagram illustrating a process performed in the first conveyance system 3a of FIG. 6. In FIG. 7, components corresponding to those in FIG. 3 are denoted by the same reference signs, and the description of each of the components denoted by the same reference signs in FIG. 3 applies to the corresponding component in FIG. 7. A difference between the process illustrated in FIG. 7 and the process illustrated in FIG. 2 is that the process of FIG. 7 does not include the processing by the rotary die cutter 13b pertaining to the front-side electrode frame film conveying system 5. In the first conveyance system 3a, a press roller 18 as a laminator-pressurizer pressurizes a laminate 19a that includes positive electrode conductor elements 9 conveyed by an electrode element conveying system 6 and an insulating frame film 7 conveyed by a back-side electrode frame film conveying system 4 and laminated on the front surfaces of the positive electrode conductor elements 9. As a result, a continuous body 24a is formed which includes elements as positive electrodes 1a, which each include the positive electrode conductor element 9 surrounded by an insulating frame 2 and are arranged in a line on a carrier belt 8a. FIG. 8 is an enlarged schematic view of the continuous body 24a.

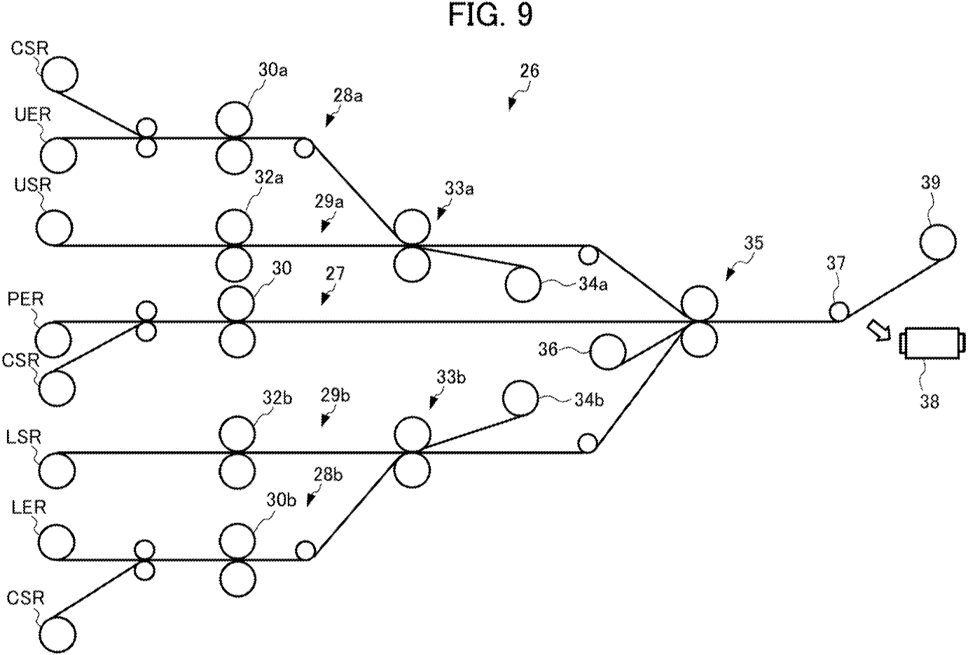

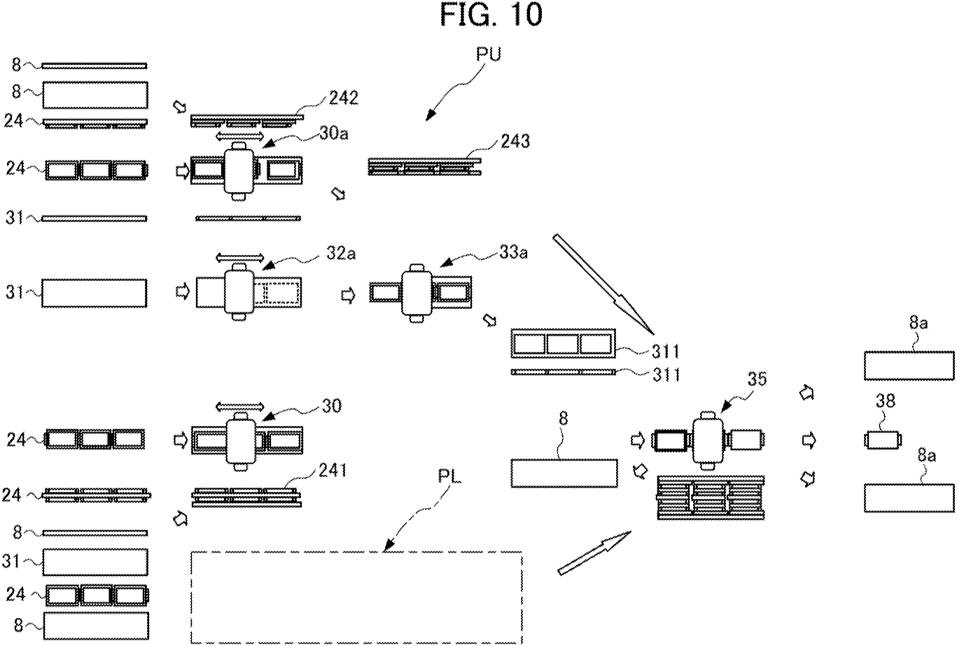

FIG. 9 is a schematic diagram illustrating a second conveyance system 26 in the apparatus for manufacturing an all-solid-state battery according to the present embodiment. FIG. 10 is a process diagram illustrating a process performed in the second conveyance system 26. The second conveyance system 26 continuously produces cells each including a solid electrolyte layer laminated between the positive electrode 1a and the negative electrode 1b, which have been formed as the continuous bodies 24 in the first conveyance system 3. The second conveyance system 26 includes a positive electrode conveying system 27, an upper negative electrode conveying system 28a, a lower negative electrode conveying system 28b, an upper solid electrolyte layer conveying system 29a, and a lower solid electrolyte layer conveying system 29b.

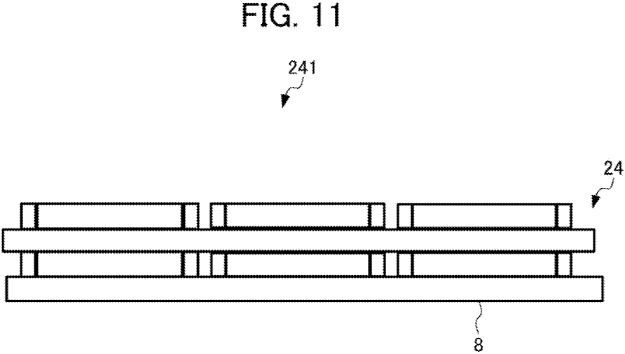

In the positive electrode conveying system 27, a press-bonding roller 30 press-bonds an applicator film 8 fed from a carrier sheet roll CSR onto the continuous body 24 of position electrodes fed from a positive electrode continuous body roll PER, thereby forming a positive electrode laminate sheet 241. FIG. 11 illustrates the positive electrode laminate sheet 241 on an enlarged scale.

In the upper negative electrode conveying system 28a, a press-bonding roller 30a press-bonds an applicator film 8 fed from a carrier sheet roll CSR onto the continuous body 24 of negative electrodes fed from an upper negative electrode continuous body roll UER, thereby forming a negative electrode laminate sheet 242.

In the lower negative electrode conveying system 28b, a press-bonding roller 30b press-bonds an applicator film 8 fed from a carrier sheet roll CSR to the continuous body 24 of negative electrodes fed from a lower negative electrode continuous body roll LER, thereby forming a negative electrode laminate sheet 242.

In the upper solid electrolyte layer conveying system 29a, a phase control rotary die 32a that also functions as a cutter forms halfway cuts in a solid electrolyte layer sheet body 31 fed from an upper solid electrolyte layer roll USR, and a press roller 33a provided downstream of the phase control rotary die 32a laminates and pressurizes the solid electrolyte layer sheet body 31 onto the continuous body 24 of negative electrodes.

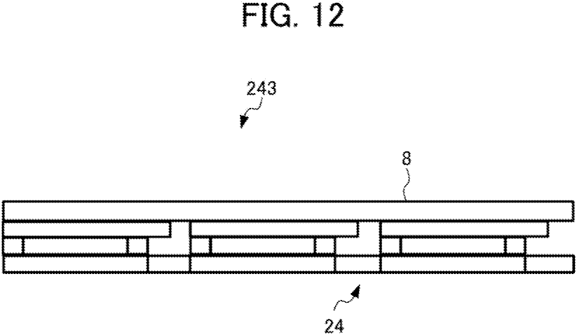

At the time of the above lamination and pressurization, the negative electrode laminate sheet 242 fed to the press roller 33a is laminated on the solid electrolyte layer sheet body 31, thereby forming a negative electrode-solid electrolyte layer laminate sheet 243. FIG. 12 illustrates the negative electrode-solid electrolyte layer laminate sheet 243 on an enlarged scale. Further, on the downstream side of the press roller 33a, an upper scrap-removing roll 34a removes an unnecessary portion 311 of the solid electrolyte layer sheet body 31 from the negative electrode-solid electrolyte layer laminate sheet 243. In FIG. 10, for the sake of convenience, the reference sign PU denotes the process that is related to the upper solid electrolyte layer conveying system 29a and that includes formation of the negative electrode-solid electrolyte layer laminate sheet 243 by the phase control rotary die 32a, the press roller 33a, and the press-bonding roller 30a as well as removal of the scrap by the upper scrap-removing roll 34a.

In the lower solid electrolyte layer conveying system 29b, a phase control rotary die 32b that also functions as a cutter forms halfway cuts in a solid electrolyte layer sheet body 31 fed from a lower solid electrolyte layer roll LSR, and a press roller 33b provided downstream of the phase control rotary die 32b laminates and pressurizes the solid electrolyte layer sheet body 31 onto the continuous body 24 of negative electrodes. At the time of the lamination and pressurization, the negative electrode laminate sheet 242 fed to the press roller 33b is laminated on the solid electrolyte layer sheet body 31, thereby forming a negative electrode-solid electrolyte layer laminate sheet 243. Further, on the downstream side of the press roller 33b, an upper scrap-removing roll 34b removes an unnecessary portion 311 of the solid electrolyte layer sheet body 31 from the negative electrode-solid electrolyte layer laminate sheet 243.

In FIG. 10, for the sake of convenience, the reference sign PL denotes the process that is related to the lower solid electrolyte layer conveying system 29b and that includes formation of the negative electrode-solid electrolyte layer laminate sheet 243 by the phase control rotary die 32b, the press roller 33b, and the press-bonding roller 30b as well as removal of the scrap by the upper scrap-removing roll 34b. Since the process PL is similar to the process PU, the process PL is represented by a chain block and the details thereof are omitted from FIG. 10.

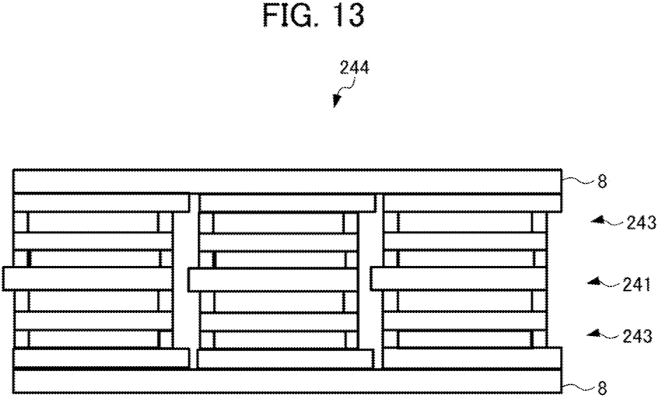

The positive electrode laminate sheet 241 formed in the positive electrode conveying system 27 and the negative electrode-solid electrolyte layer laminate sheets 243 formed in the processes PU and PL and subjected to removal of the scraps are conveyed, as a negative electrode-positive electrode-solid electrolyte layer laminate 244, to a press roller 35. FIG. 13 illustrates the negative electrode-positive electrode-solid electrolyte layer laminate 244 on an enlarged scale.

Before the negative electrode-positive electrode-solid electrolyte layer laminate 244 is pressurized by the press roller 35, a scrap-removing roll 36 removes the upper and lower applicator films 8 that are unnecessary portions for the negative electrode-positive electrode-solid electrolyte layer laminate 244. Following the removal of the scraps, the press roller 35 pressurizes the negative electrode-positive electrode-solid electrolyte layer laminate 244. Thereafter, a collecting roll 37 provided downstream of the press roller 35 collects all-solid-state cells 38, and a scrap-removing roll 39 removes the carrier belts 8a, which are no longer necessary.

The apparatus for manufacturing an all-solid-state battery according to the present embodiment exerts the following effects.

(1) The apparatus 1 for manufacturing an all-solid-state battery includes: the electrode element conveying system 6 configure to convey the positive electrode conductor element 9 adapted to function as the positive electrode 1a that is an element of the all-solid-state battery or the negative electrode conductor element 10 adapted to function as the negative electrode 1b that is an element of the all-solid-state battery; the back-side electrode frame film conveying system 4 and optionally the front-side electrode frame film conveying system 5 configured to convey the insulating frame film 7 adapted to function as the insulating frame 2 that is an element of the all-solid-state battery; the rotary die cutter 13a and optionally the rotary die cutter 13b configured to punch and cut the insulating frame film 7, a cut in correspondence with the shape of the insulating frame 2; and the press roller 18 configured to laminate and pressurize the positive electrode conductor element 9 or the negative electrode conductor element 10 conveyed by the electrode element conveying system 6 and the insulating frame films 7 punched and cut by the rotary die cutter 13a or the rotary die cutter 13b. Due to this feature, the electrode element conveying system 6, the back-side electrode frame film conveying system 4, the front-side electrode frame film conveying system 5, the rotary die cutter 13a, the rotary die cutter 13b, and the press roller 18 function while continuing the conveying operation. As a result, the apparatus 1 can manufacture the all-solid-state batteries with high efficiency.

(2) In the manufacturing apparatus 1, the back-side electrode frame film conveying system 4 and optionally the front-side electrode frame film conveying system 5 convey the insulating frame film 7 together with the applicator film 8 while fitting the applicator film 8 on the insulating frame film 7 such that the films 7 and 8 are layered on each other, and the rotary die cutter 13a forms a cut in the insulating frame film 7 conveyed by the back-side electrode frame film conveying system 4, and optionally, the rotary die cutter 13b forms a cut in the insulating frame film 7 being conveyed by the front-side electrode frame film conveying system 5. Specifically, the rotary die cutter 13a and optionally the rotary die cutter 13b form, in the insulating frame film 7 layered on and conveyed together with the applicator film 8, such a halfway cut that allows a portion of the insulating frame film 7 to be peeled off. As a result, the insulating frame film 7 subjected to the cutting also continues to be conveyed together with the applicator film 8.

(3) In the manufacturing apparatus 1, at least one of the electrode element conveying system 6 or the back-side or front-side electrode frame film conveying system 4 or 5 includes an adjustment mechanism 16 configured to hold the positive or negative electrode conductor element 9 or 10 or the insulating frame film 7 under a tension in an area upstream of the press roller 18 in the conveying direction. This feature makes the positive or negative electrode conductor element 9 or 10 or the insulating frame film 7 free from slack. As a result, the positive or negative electrode conductor element 9 or 10 or the insulating frame film 7 is appropriately laminated and pressurized.

(4) The manufacturing apparatus 1 further includes the upper peeling roll 21a, the lower peeling roll 21b, the upper scrap-removing roll 22a, and the lower scrap-removing roll 22b that are provided downstream of the press roller 18 in the conveying direction and configured to peel off a portion of the insulating frame film 7, the portion being other than a portion shaped by the rotary die cutter 13a or the rotary die cutter 13b into the insulating frame 2 as the element of the all-solid-state battery. Due to this feature, the all-solid-state batteries including the insulating frame 2 devoid of the unnecessary portion are successively manufactured.

While the embodiment of the present invention has been described above, the present invention is not limited to the embodiment described above. Modifications may be made as appropriate to the specifics of the present invention without deviating from the spirit of the present invention. For example, the adjustment mechanism 16, which is configured to control a rotation speed of the phase control rotary die 17 and not a rotation speed of the press roller 18 in the above embodiment, may be configured to adjust a distance between the shaft of the phase control rotary die 17 and the shaft of the press roller 18.

### EXPLANATION OF REFERENCE NUMERALS

CSR: Carrier sheet roll
ER: Electrode element conveyable sheet roll
FR: Insulating frame film roll
LER: Lower negative electrode continuous body roll
LSR: Lower solid electrolyte layer roll
PE: Positive electrode conductor
PER: Positive electrode continuous body roll
PL, PU: Process
NE: Negative electrode conductor
TP: Positive electrode tab
TN: Negative electrode tab
UER: Upper negative electrode continuous body roll
USR: Upper solid electrolyte layer roll
1a: Positive electrode
   1b: Negative electrode
1: Apparatus for manufacturing all-solid-state battery
2: Insulating frame
3, 3a: First conveyance system
4: Back-side electrode frame film conveying system (Insulator conveyor)
5: Front-side electrode frame film conveying system (Insulator conveyor)
6: Electrode element conveying system (Conductor conveyor)
7: Insulating frame film (Insulator)
8: Applicator film (Carrier)
8a: Carrier belt
9: Positive electrode element
10: Negative electrode element
11a: Conveyable sheet with first structure
11b: Conveyable sheet with second structure
11c: Conveyable sheet with third structure
12: Window-shaped punched scrap
13a: Rotary die cutter
13b: Rotary die cutter
14a: Assistance roll
14b: Assistance roll
15: Positional phase sensor
16: Adjustment mechanism
17: Phase control rotary die
18: Press roller
19, 19a: Laminate
20: Incision
21a: Upper peeling roll
21b: Lower peeling roll
22a: Upper scrap-removing roll
22b: Lower scrap-removing roll
23a: Unnecessary portion
23b: Unnecessary portion
24, 24a: Continuous body
25: Winding roll
26: Second conveyance system
27: Positive electrode conveying system
28a: Upper negative electrode conveying system
28b: Lower negative electrode conveying system
29a: Upper solid electrolyte layer conveying system
29b: Lower solid electrolyte layer conveying system
30, 30a, 30b: Press-bonding roller
31: Solid electrolyte layer sheet body
32a, 32b: Phase control rotary die
33a, 33b: Press roller
34a: Upper scrap-removing roll
35: Press roller
36: Scrap-removing roll
37: Collecting roll
38: All-solid-state cell
39: Scrap-removing roll
241: Positive electrode laminate sheet
242: Negative electrode laminate sheet
243: Negative electrode-solid electrolyte layer laminate sheet
244: Negative electrode-positive electrode-solid electrolyte layer laminate
311: Unnecessary portion

What is claimed is:

1. An apparatus for manufacturing an all-solid-state battery, the apparatus comprising:
a conductor conveyor configured to convey a conductor adapted to function as an electrode that is an element of the all-solid-state battery;
an insulator conveyor configured to convey an insulator adapted to function as an insulating member that is an element of the all-solid-state battery;
a cutter configured to form, in the insulator, a cutter configured to punch and cut the insulator in correspondence with a shape of the insulating member; and
a laminator-pressurizer configured to laminate and pressurize the conductor conveyed by the conductor conveyor and the insulator punched and cut by the cutter.

2. The apparatus according to claim 1, wherein
the insulator conveyor conveys the insulator together with a carrier sheet while fitting the carrier sheet on the insulator such that the insulator and the carrier sheet are layered on each other, and
the cutter forms a cut in the insulator being conveyed by the insulator conveyor.

3. The apparatus according to claim 1, wherein
at least one of the conductor conveyor or the insulator conveyor includes a tensioner configured to hold the conductor or the insulator under a tension in an area upstream of the laminator-pressurizer in a conveying direction of the conductor conveyor and the insulator conveyor.

4. The apparatus according to claim 1, further comprising:
a peeler provided downstream of the laminator-pressurizer in a conveying direction of the insulator conveyor, and configured to peel off a portion of the insulator, the portion being other than a portion shaped by the cutter into the insulating member that is the element of the all-solid-state battery.
